(19) United States
(12) Patent Application Publication
(10) Pub. No.: US 2024/0303350 A1
(43) Pub. Date: Sep. 12, 2024

(54) METHOD AND APPARATUS FOR MANAGING MULTIMEDIA FILE RELATED TO DOCUMENT

(71) Applicant: TmaxOffice Co., Ltd, Gyeonggi-Do (KR)

(72) Inventors: Je-chan Lee, Gyeonggi-Do (KR); Jaehyeok Son, Gyeonggi-Do (KR); Seungjoon Yang, Gyeonggi-Do (KR); Moon Namkoong, Gyeonggi-Do (KR)

(21) Appl. No.: 18/137,548

(22) Filed: Apr. 21, 2023

(30) Foreign Application Priority Data
Mar. 6, 2023 (KR) 10-2023-0029100

(51) Int. Cl. G06F 21/60; G06F 16/41

(52) U.S. Cl. CPC G06F 21/602; G06F 16/41

(57) ABSTRACT

In an exemplary embodiment, a method for managing a multimedia file related to a document is discloses. For instance, the method being performed by a first computing device. The method comprises, obtaining a multimedia file related to a document, generating character string data by encoding the multimedia file, generating a key value by encrypting the generated character string data, determining whether a key value equal to the generated key value exists in a pre-stored data table comprising a plurality of key values and character string data of the multimedia file corresponding to each key value, when the key value equal to the generated key value does not exist, storing the key value and the character string data in the data table by matching the generated key value and the generated character string data, and transmitting the multimedia file related to the document to the server so that server stores the multimedia file related to the document.

### CROSS-REFERENCE TO RELATED APPLICATION

This application claims priority to and the benefit of Korean Patent Application No. 10-2023-0029100 filed in the Korean Intellectual Property Office on Mar. 6, 2023, the entire contents of which are incorporated herein by reference.

### TECHNICAL FIELD

The present disclosure relates to a method and an apparatus for managing a multimedia file related to a document.

### BACKGROUND

Typically, users use an electronic document editing program installed on an electronic device to create or edit electronic documents that include not only text but also multimedia files, such as figures, tables, formulas, and/or images. The multimedia files inserted into the electronic document may be stored and managed separately on the electronic device or on a server related to the electronic device.

However, multimedia files already stored on the electronic device or server may be saved again when another electronic document including the same multimedia file is saved, so that the multimedia file may be duplicatedly stored and managed, to cause a waste of memory capacity.

Accordingly, there is a need for a method and an apparatus for efficiently managing the same multimedia file included in a plurality of documents.

### SUMMARY

The present disclosure has been conceived in response to the foregoing background art, and has been made in an effort to provide a method and an apparatus for managing a multimedia file related to a document.

The technical objects of the present disclosure are not limited to the foregoing technical objects, and other non-mentioned technical objects will be clearly understood by those skilled in the art from the description below.

In order to solve the foregoing object, an exemplary embodiment of the present disclosure discloses a method for managing a multimedia file related to a document. The method can be performed by a first computing device. The method comprises: obtaining a multimedia file related to a document, generating character string data by encoding the multimedia file, generating a key value by encrypting the generated character string data, determining whether a key value equal to the generated key value exists in a pre-stored data table comprising a plurality of key values and character string data of the multimedia file corresponding to each key value, when the key value equal to the generated key value does not exist, storing the key value and the character string data in the data table by matching the generated key value and the generated character string data, and transmitting the multimedia file related to the document to the server so that server stores the multimedia file related to the document.

Alternatively, wherein the multimedia file related to the document comprises a multimedia file inserted into the document, or a multimedia file included in the document.

Alternatively, the method further comprises: receiving a request for inserting a first multimedia file into the document, generating first character string data by encoding the first multimedia file according to the received request, generating a first key value by encrypting the first character string data, determining whether a key value equal to the first key value exists in the data table, and when the key value equal to the first key value exists, inserting the first multimedia file into the document by using the character string data from the multimedia file corresponding to the key value equal to the first key value.

Alternatively, wherein the inserting of the first multimedia file into the document by using the character string data from the multimedia file corresponding to the key value equal to the first key value comprises inserting character string data of the multimedia file corresponding to the key value equal to the first key value into the document.

Alternatively, the method further comprises: inserting the first multimedia file into the document when the key value equal to the first key value does not exist, storing the first key value and the first character string data in the data table by matching the first key value and the first character string data, and transmitting the first multimedia file corresponding to the first key value to the server so that the server stores the first multimedia file corresponding to the first key value.

Alternatively, the method further comprises: receiving a request for loading the document, determining, in response to the received request, whether a key value equal to a second key value of a second multimedia file included in the document exists in the pre-stored data table, and when the key value equal to the second key value exists, loading the document by using character string data corresponding to the key value equal to the second key value.

Alternatively, wherein the loading of the document by using character string data corresponding to the key value equal to the second key value comprises: rendering each page of the document, rendering the second multimedia file of the second document by decoding the character string data, and outputting each of the rendered pages and the rendered second multimedia file.

Alternatively, the method further comprises: when the key value equal to the second key value does not exist, requesting the second multimedia file to the server, when the second multimedia file is received from the server, rendering each page of the document and the received second multimedia file and outputting each of the rendered pages and the rendered second multimedia file.

In order to solve the foregoing object, an exemplary embodiment of the present disclosure discloses a method for managing a multimedia file related to a document. The method can be performed by a second computing device. The method comprises: receiving a multimedia file corresponding to a key value from a client device, generating metadata for the multimedia file, storing the received multimedia file in a pre-stored multimedia file table comprising a plurality of multimedia files, and storing the generated metadata in a metadata table that comprises metadata of each of the plurality of multimedia files and wherein the metadata table is pre-stored in a database.

Alternatively, wherein the storing of the received multimedia file in the multimedia file table comprises storing an ID of the multimedia file, the key value, and the multimedia file in the multimedia file table by matching the ID of the multimedia file, the key value, and the multimedia file.

Alternatively, wherein the storing of the generated metadata in the metadata table comprises storing the key value and the metadata in the metadata table by matching the key value and the metadata.

Alternatively, wherein a multimedia file stored in the multimedia file table and a metadata file stored in the metadata table are associated to each other by the key value.

Alternatively, the method further comprises: receiving a request for a multimedia file corresponding to the key value from the client device, retrieving, in accordance with the received request, the requested multimedia file from the multimedia file table, retrieving metadata of the requested multimedia file from the metadata table stored in the database, and transmitting the retrieved multimedia file and the retrieved metadata to the client device.

In order to solve the foregoing object, an exemplary embodiment of the present disclosure discloses a computer program stored in a computer readable storage medium. When the computer program is executed by one or more processors, the computer program performs following operations for managing a multimedia file related to a document. The operations comprises: obtaining a multimedia file related to a document, generating character string data by encoding the multimedia file, generating a key value by encrypting the generated character string data, determining whether a key value equal to the generated key value exists in a pre-stored data table comprising a plurality of key values and character string data of the multimedia file corresponding to each key value, when the key value equal to the generated key value does not exist, storing the key value and the character string data in the data table by matching the generated key value and the generated character string data, and transmitting the multimedia file related to the document to the server so that server stores the multimedia file related to the document.

In order to solve the foregoing object, an exemplary embodiment of the present disclosure discloses a computing device for managing a multimedia file related to a document. The computing device comprises at least one processor and a memory. wherein said at least one processor: obtains a multimedia file related to a document, generates character string data by encoding the multimedia file, generates a key value by encrypting the generated character string data, determines whether a key value equal to the generated key value exists in a pre-stored data table comprising a plurality of key values and character string data of the multimedia file corresponding to each key value, when the key value equal to the generated key value does not exist, stores the key value and the character string data in the data table by matching the generated key value and the generated character string data, and transmits the multimedia file related to the document to the server so that server stores the multimedia file related to the document.

According to some exemplary embodiments of the present disclosure, it is possible to efficiently manage data related to a document or multimedia file in each of an electronic device and a server.

According to some exemplary embodiments of the present disclosure, it is possible to save memory capacity for storing a multimedia file by storing the corresponding multimedia file once even when the same multimedia file is included in a plurality of documents.

According to some exemplary embodiments of the present disclosure, when duplicate multimedia file-related data exists in an electronic device at the time of document loading, the document including the multimedia file is loaded by using the data stored in the electronic device, thereby facilitating document loading without a separate request to the server.

The effects of the present disclosure are not limited to the foregoing effects, and other non-mentioned effects will be clearly understood by those skilled in the art from the description below.

### BRIEF DESCRIPTION OF THE DRAWINGS

Various aspects are described with reference to the drawings. Herein, like reference numerals are generally used to designate like constituent elements. In the exemplary embodiment below, for the purpose of description, a plurality of specific and detailed matters is suggested in order to provide general understanding of one or more aspects. However, it is apparent that the aspect(s) may be carried out without the specific and detailed matters.

FIG. 1 is a configuration diagram of an exemplary system for managing multimedia files related to documents according to an exemplary embodiment of the present disclosure.

FIG. 2 is a configuration diagram of a client device according to an exemplary embodiment of the present disclosure.

FIG. 3 is a configuration diagram of a server according to an exemplary embodiment of the present disclosure.

FIG. 4 is a flowchart for describing an exemplary method for managing multimedia files related to documents according to an exemplary embodiment of the present disclosure.

FIG. 5 is a diagram for describing an exemplary method for managing multimedia files included in documents in a client application according to an exemplary embodiment of the present disclosure.

FIG. 6 is a flowchart for describing an exemplary method for storing and managing multimedia files according to an exemplary embodiment of the present disclosure.

FIG. 7 is a diagram for describing an exemplary method for storing and managing multimedia files by a server application according to an exemplary embodiment of the present disclosure.

FIG. 8 is a diagram for describing an exemplary method for associating multimedia files and metadata using a foreign key according to an exemplary embodiment of the present disclosure.

FIG. 9 is a flowchart for describing an exemplary method for storing and managing a first multimedia file when requesting to insert the first multimedia file into a first document according to an exemplary embodiment of the present disclosure.

FIGS. 10A and 10B are flowcharts for describing an exemplary method for storing and managing a second multimedia file when requesting to load the second document in which the second multimedia file is included, according to an exemplary embodiment of the present disclosure.

FIG. 11 is a flowchart for describing an exemplary method for storing a multimedia file by a server in response to a client request according to an exemplary embodiment of the present disclosure.

FIG. 12 is a flowchart for describing an exemplary method for providing a multimedia file by a server in response to a client request according to an exemplary embodiment of the present disclosure.

FIG. 13 is a simple and general schematic diagram illustrating an example of a computing environment in which the embodiments of the present disclosure are implementable.

### DETAILED DESCRIPTION

Various exemplary embodiments are described with reference to the drawings. In the present specification, various descriptions are presented for understanding the present disclosure. However, it is obvious that the exemplary embodiments may be carried out even without a particular description.

Terms, “component”, “module”, “unit”, “system”, and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

A term “or” intends to mean comprehensive “or”, not exclusive “or”. That is, unless otherwise specified or when it is unclear in context, “X uses A or B” intends to mean one of the natural comprehensive substitutions. That is, when X uses A, X uses B, or X uses both A and B, “X uses A or B” may be applied to any one among the cases. Further, a term “and/or” used in the present specification shall be understood to designate and include all of the possible combinations of one or more items among the listed relevant items.

A term “include/comprise” and/or “including/comprising” shall be understood as meaning that a corresponding characteristic and/or a constituent element exists. Further, it shall be understood that a term “include” and/or “including” means that the existence or an addition of one or more other characteristics, constituent elements, and/or a group thereof is not excluded. Further, unless otherwise specified or when it is unclear that a single form is indicated in context, the singular shall be construed to generally mean “one or more” in the present specification and the claims.

The term “at least one of A and B” should be interpreted to mean “the case including only A”, “the case including only B”, and “the case where A and B are combined”.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, such implementation decisions should not be interpreted as causing a departure from the scope of the present disclosure.

The description about the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Therefore, the present disclosure is not limited to the exemplary embodiments presented herein. The present disclosure shall be interpreted within the broadest meaning range consistent to the principles and new characteristics presented herein.

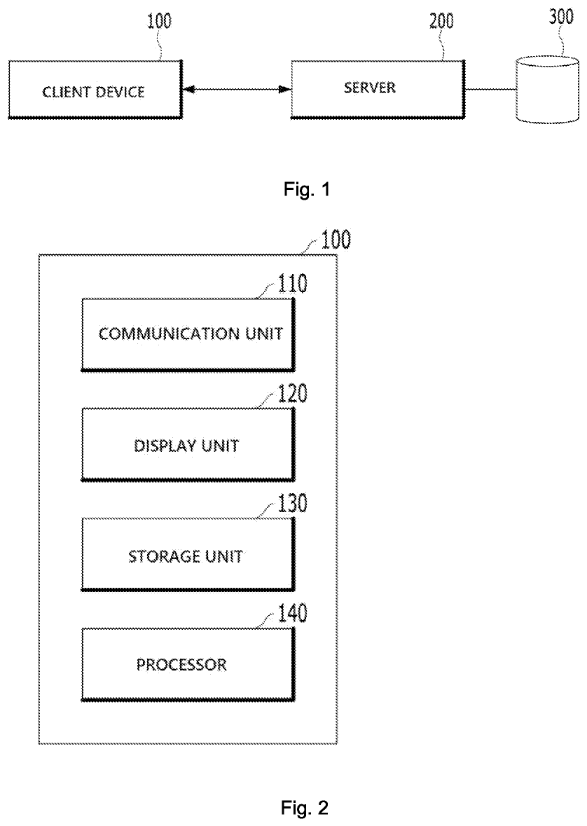

FIG. 1 is a block diagram of an example of a system for managing a multimedia file related to a document according to an exemplary embodiment of the present disclosure.

Referring to FIG. 1, the system may include a client device 100, a server 200, and a database 300 of the server 200. The components illustrated in FIG. 1 are illustrative, and additional components may be present or some of the components may be omitted.

According to some exemplary embodiments of the present disclosure, the client device 100 and the server 200 may transmit and receive various data to and from each other via a wireless communication network for storing/managing multimedia files according to some exemplary embodiments of the present disclosure.

The client device 100 may include a PC, a laptop computer, a workstation, a user terminal, and/or any other electronic device having network connectivity for storing, managing, or requesting multimedia files included in a document. Further, the client device 100 may also include a predetermined server implemented by at least one of an agent, an Application Programming Interface (API), and plug-in. Additionally, the client device 100 may include an application source and/or a client application.

Specifically, the client device 100 may perform operations of determining whether to store a multimedia file related to a document, inserting a multimedia file into a document at the request of a client (that is, a user), or loading a document including a multimedia file. In the presented exemplary embodiments, a multimedia file may refer to one or one or more multimedia files.

According to the exemplary embodiment of the present disclosure, a document is a document in a variety of file formats that is readable by a browser on the client device 100, and may mean, for example, a document in HTML/XML format consisting of text, but is not limited thereto.

According to the exemplary embodiment of the present disclosure, a multimedia file may refer to figures, tables, formulas, and/or images.

According to the exemplary embodiment of the present disclosure, including or inserting a multimedia file in a document may mean that the multimedia file is represented within the document in the form of the language of the document. For example, when the document is an HTML/XML document, a multimedia file may be represented in the HTML/XML format and included or inserted into the document.

According to some exemplary embodiments of the present disclosure, the client device 100 may be any entity which includes a control unit, a storage unit (memory and persistent storage media), a communication unit, and a display unit and is capable of processing, storing, transmitting, receiving, and outputting any data.

The control unit of the disclosure may include one or more cores and may include any form of processor, such as a Central Processing Unit (CPU), General Purpose Graphics Processing Unit (GPGPU), Tensor Processing Unit (TPU), or the like of a computing device for providing a document including multimedia files by executing instructions stored in a memory. The processor may read a computer program stored in memory to perform multimedia file storage and/or management according to the exemplary embodiment of the present disclosure.

The storage unit of the present disclosure may store a program for the operation of the control unit, and may temporarily or permanently store input/output data. The storage unit may include at least one type of storage medium among a flash memory type, a hard disk type, a multimedia card micro type, a card type of memory (for example, an SD or XD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk. The storage unit may be operated under the control of the control unit. In addition, the memory and the storage unit of the present disclosure may be used interchangeably with each other.

The communication unit of the present disclosure may connect the client device 100 to communicate with various devices. Specifically, the communication unit may be connected with external devices to send and receive various data related to the storage/management of multimedia files.

The display unit of the present disclosure may display various contents to the user. According to some exemplary embodiments of the present disclosure, the display unit may output an interface screen for adding a multimedia file to a document, or for loading a document including a multimedia file.

The server 200 may include any type of computer system or computer device, such as a computer, a digital processor, a portable device, and a device controller, for storing, managing, and/or providing multimedia files and/or documents.

Specifically, when the multimedia file and/or document is received from the client device 100, the server 200 may store the multimedia file and/or document in the storage unit of the server 200 and/or in the database 300 connected with the server 200.

According to some exemplary embodiments of the present disclosure, the server 200 may be any entity which includes a processor, a storage unit (memory and persistent storage media), and a communication unit, and is capable of processing, storing, and sending and receiving any data.

The processor of the present disclosure may include one or more cores and may include any form of a processor, such as a CPU, a GPGPU, a TPU, and a GPU of a computing device, for storing, managing, and/or providing a multimedia file and/or document by executing instructions stored in a memory. The processor may read a computer program stored in the memory to perform operations to store, manage, and/or provide multimedia files and/or documents according to the exemplary embodiments of the present disclosure.

The memory of the present disclosure may store programs for the operation of the processor, and may temporarily or permanently store input/output data. The memory may include at least one type of storage media among a flash memory type, a hard disk type, a multimedia card micro type, a card type memory (for example, SD or XD memory), a RAM, an SRAM, a ROM, an EEPROM, a PROM, a magnetic memory, a magnetic disk, and an optical disk. The memory may be operated under the control of the processor. In addition, the memory and the storage unit of the present disclosure may be used interchangeably with each other.

The storage unit according to the present disclosure may store a variety of data to store, manage, and/or provide multimedia files and/or documents. In particular, the storage unit may store multimedia files and/or documents, or may store metadata of multimedia files, but is not limited to.

The communication unit of the present disclosure may connect the server 200 to communicate with various devices. Specifically, the communication unit may receive and transmit data to and from the client device 100.

The database 300 may be connected with the server 200 to store multimedia files and/or documents. According to some exemplary embodiments of the present disclosure, the database 300 may store databased multimedia files and/or databased documents. For example, the database 300 may be, but is not limited to, a relational database.

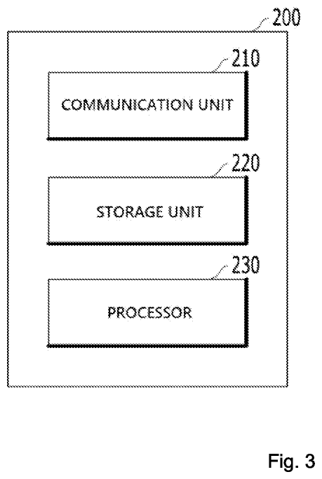

FIG. 2 is a block diagram of the client device according to the exemplary embodiment of the present disclosure. The configuration of the client device 100 illustrated in FIG. 2 is only a simplified example. In the exemplary embodiment of the present disclosure, the client device 100 may include other configurations for performing the computing environment of the client device 100, and only some of the disclosed configurations may configure the client device 100.

The client device 100 may include a communication unit 110, a display unit 120, a storage unit 130, and a processor 140. However, the components described above are not essential to implement the client device 100, and the client device 100 may have fewer or more components than those listed above. Herein, each of these components may be configured as a separate chip, module, or device, or may be included within a single device.

The communication unit 110 according to the exemplary embodiment of the present disclosure may include any form of wired or wireless internet module for network access. In the presented exemplary embodiment, the communication unit 110 may utilize various forms of known wired and wireless networks.

According to some exemplary embodiments of the present disclosure, the communication unit 110 connects the client device 100 to communicate with an external device. The communication unit 110 may transmit requests to store multimedia files and/or documents to the server 200 by using wired or wireless communication. Further, the communication unit 110 may request multimedia files and/or documents from the server 200 and receive the requested multimedia files and/or documents from the server 200.

According to the exemplary embodiment of the present disclosure, the display unit 120 may display various contents to the user. According to some exemplary embodiments of the present disclosure, the display unit 120 may display various interface screens for inserting a multimedia file into a document, or for loading a document including a multimedia file. In various exemplary embodiments, the display unit 120 may include a touch screen and may receive touch, gesture, proximity, drag, swipe, or hovering input, for example, by using an electronic pen or a part of a user's body (for example, a finger).

According to the exemplary embodiment of the present disclosure, the storage unit 130 may store any form of information generated or determined by the processor 140 and any form of information received by the communication unit 110. According to some exemplary embodiments of the present disclosure, the storage unit 130 may store various data used to store/manage/provide multimedia files related to the document.

The storage unit 130 may include a memory and/or a persistent storage medium. The storage unit 130 may include at least one type of storage media among a flash memory type, a hard disk type, a multimedia card micro type, a card type memory (for example, SD or XD memory), a RAM, an SRAM, a ROM, an EEPROM, a PROM, a magnetic memory, a magnetic disk, and an optical disk. Server A 200 may also operate in association with web storage which performs storage functions of the storage unit 130 on the internet. The foregoing description of the storage unit is by way of example only, and the present disclosure is not limited thereto.

The processor 140 may include one or more cores and may include a processor, such as a central processing unit (CPU), a general purpose graphics processing unit (GPGPU), and a tensor processing unit (TPU) of a computing device, for data analysis and processing.

The processor 140 may read a computer program stored in the storage unit 130 to perform various operations to store/manage/provide multimedia files related to documents according to the exemplary embodiment of the present disclosure.

Specifically, the processor 140 may convert the multimedia file related to the document to character string data and store the character string data, or request that the server 200 stores the multimedia file.

To convert the multimedia file to character string data, the processor 140 may utilize a method of encoding binary data into text. The encoding method may include, but are not limited to, base64, and the like. For example, the character string data may be, but is not limited to, a dataURL.

In order to store the character string data, the processor 140 may encrypt the character string data to generate a key value, match the generated key value to the character string data, and store the key value and character string data in a data table. Here, the data table may include a plurality of key values and the character string data corresponding to each key value (that is, character string data generated by encoding the multimedia file).

In order to generate the key value, the processor 140 may utilize an encryption function or encryption algorithm to generate the key value from the character string data. For example, the processor 140 may extract a hash value from the character string data by using a hash function or hash algorithm and utilize the extracted hash value as the key value, but the present disclosure is not limited to.

In various exemplary embodiments, when the same multimedia file exists for each of the plurality of documents, the processor 140 may store the key values and the character string data for the corresponding multimedia file once in the data table. For example, the processor 140 may match a key value to character string data for a multimedia file included in one document of the plurality of documents and store the key value and the character string data in a data table, and when a key value equal to a key value of a multimedia file included in another document among the plurality of documents is present in the data table, the processor 140 may not perform a storage operation with respect to the same multimedia file included in in another document.

According to some exemplary embodiments of the present disclosure, the processor 140 may receive a request to insert a first multimedia file into a first document.

According to the received request, the processor 140 may encode the first multimedia file to generate character string data, and encrypt the generated character string data to obtain a first key value. The processor 140 may determine whether a key value equal to the obtained first key value exists in a pre-stored data table, and when the key value equal to the first key value exists, the processor 140 may insert the first multimedia file into the first document by using character string data corresponding to the key value equal to the first key value.

When a key value equal to the first key value does not exist, the processor 140 may insert the first multimedia file into the first document by using the character string data of the first multimedia file and transit the first multimedia file to the server 200 for the server 200 to store the first multimedia file.

According to some exemplary embodiments of the present disclosure, the processor 140 may receive a request to load a second document that includes a second multimedia file.

According to the received request, the processor 140 may determine whether a key value equal to the second key value of the second multimedia file included in the second document exists in the pre-stored data table.

When a key value equal to the second key value exists, the processor 140 may load the second document including the second multimedia file by using the character string data corresponding to the key value equal to the second key value. When the key value equal to the second key value does not exist, the processor 140 may request the second multimedia file from the server 200 and receive the second multimedia file and metadata of the second multimedia file from the server 200. The processor 140 may use the received second multimedia file and metadata to render and output the second document including the second multimedia file.

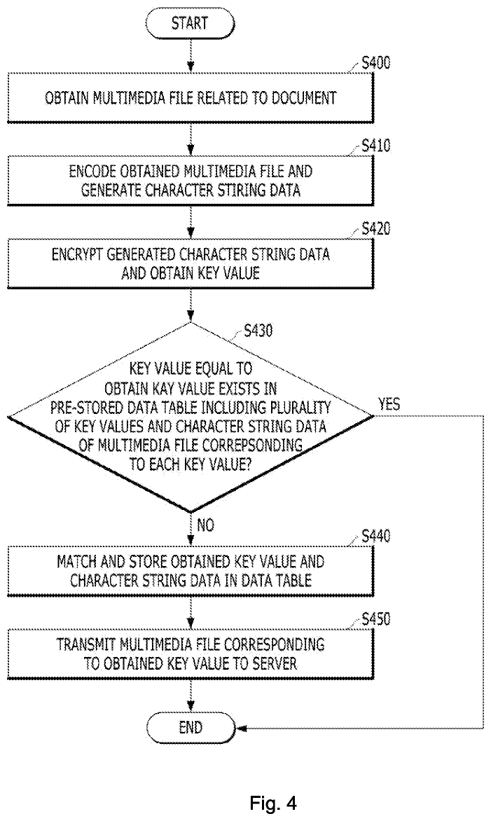

FIG. 3 is a block diagram of the server according to the exemplary embodiment of the present disclosure. The configuration of the server 200 illustrated in FIG. 3 is only a simplified example. In the exemplary embodiment of the present disclosure, the server 200 may include other configurations for performing the computing environment of the server 200, and only some of the disclosed configurations may configure the server 200.

The server 200 may include a communication unit 210, a storage unit 220, and a processor 230. However, the components described above are not essential to implement the server 200, and the server 200 may include fewer or more components than those listed above. Herein, each of these components may be configured as a separate chip, module, or device, or may be included within a single device.

The communication unit 210 according to the exemplary embodiment of the present disclosure may include any form of wired or wireless internet module for network access. In the presented exemplary embodiment, the communication unit 210 may utilize various forms of known wired and wireless networks.

According to some exemplary embodiments of the present disclosure, the communication unit 210 connects the server 200 to communicate with external devices. The communication unit 210 may receive a multimedia file corresponding to a predetermined key value and/or a document including a multimedia file from the client device 100 by using wired or wireless communication.

According to some exemplary embodiments of the present disclosure, the communication unit 210 may receive a request from the client device 100 for a multimedia file corresponding to a specific key value, and transmit the requested multimedia file to the client device 100.

According to the exemplary embodiment of the present disclosure, the storage unit 220 may store any form of information generated or determined by the processor 230 and any form of information received by the communication unit 210. According to some exemplary embodiments of the present disclosure, the storage unit 220 may store various data used to store/manage multimedia files and/or documents.

The storage unit 220 may include a memory and/or a persistent storage medium. The storage unit 220 may include at least one type of storage media among a flash memory type, a hard disk type, a multimedia card micro type, a card type memory (for example, SD or XD memory), a RAM, an SRAM, a ROM, an EEPROM, a PROM, a magnetic memory, a magnetic disk, and an optical disk. The server 200 may also operate in association with web storage that performs storage functions of the storage unit 220 on the Internet. The foregoing description of the storage unit is by way of example only, and the present disclosure is not limited thereto.

The processor 230 may include one or more cores and may include a processor, such as a central processing unit (CPU), a general purpose graphics processing unit (GPGPU), and a tensor processing unit (TPU) of a computing device, for data analysis and processing.

The processor 230 may read computer programs stored in the storage unit 220 to perform various operations for storing/managing multimedia files and/or documents according to the exemplary embodiment of the present disclosure.

In particular, the processor 230 may receive a multimedia file corresponding to a specific key value from client device 100. The processor 230 may generate metadata for the received multimedia file. Here, metadata is attribute information about a multimedia file, which may include, but is not limited to, name, size (height, width), location where the multimedia file is inserted (for example, coordinate information), or file type (or extension). For example, when the multimedia file is a table, the metadata might include, but is not limited to, the size of the table, the location where the table is inserted, and the number of rows/columns.

The processor 230 may store the received multimedia files in the storage unit 220 in a table form, and store the generated metadata in the database 300 in a table form. In order to prevent duplicate storage of the same multimedia file when a multimedia file is stored, the processor 230 may change a name of the multimedia file to a key value of the corresponding multimedia file and store the key value.

A table in which multimedia files are stored (hereinafter referred to as a “multimedia file table”) may store identification information (element id) of a multimedia file, a multimedia file corresponding to the identification information, and a key value of the corresponding multimedia file. In addition, the table in which the metadata is stored (hereinafter referred to as the “metadata table”) may store the key value of the multimedia file and metadata corresponding to the key value.

The processor 230 may associate each multimedia file stored in the multimedia file table and each metadata stored in the metadata table with each other by using a foreign key. Here, the foreign key may be a key used to define the relationship between the table in which the multimedia file is stored and the table in which the metadata is stored. In some exemplary embodiments of the present disclosure, the foreign key may be a key value corresponding to a multimedia file.

According to some exemplary embodiments of the present disclosure, when a request for a multimedia file is received from the client device 100, the processor 230 may determine whether the requested multimedia file is stored, and when the corresponding requested multimedia file is stored, the processor 230 may transmit the corresponding multimedia file to the client device 100. When the corresponding multimedia file is not stored, the processor 230 may transmit an error message to the client device 100.

Thus, the present disclosure enables efficient management of multimedia files related to documents in the client device and the server.

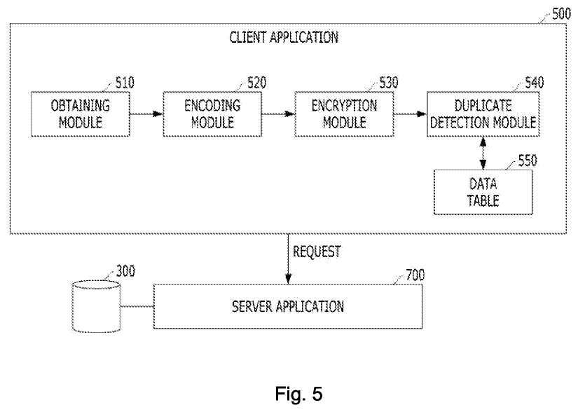

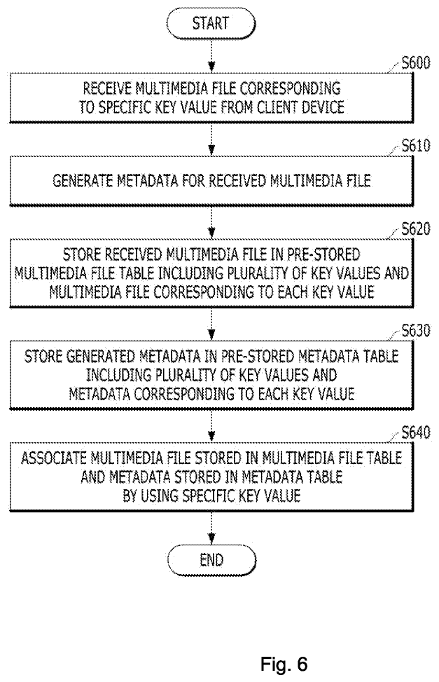

Hereinafter, a method of managing a multimedia file included in a document by the client device 100 will be described in detail with reference to FIGS. 4 and 5.

FIG. 4 is a flow diagram for illustrating one example of a method of managing a multimedia file included in a document according to an exemplary embodiment of the present disclosure. In the presented exemplary embodiment, the operations of FIG. 4 may be performed by the processor 140 of the client device 100.

Referring to FIG. 4, the processor 140 obtains a multimedia file related to a document (S400) and encodes the obtained multimedia file to generate character string data (S410). In this context, a multimedia file related to a document may mean a multimedia file that is included in or inserted into a document.

In order to encode the multimedia file to generate character string data, the processor 140 may utilize, for example, but not limited to, base64 that is a character string encoding scheme for representing arbitrary binary data as an ASCII character string.

The processor 140 encrypts the generated character string data to obtain the key value (S420). Specifically, the processor 140 may utilize a hash function or hash algorithm to generate a fixed-length value or a hash value from character string data having a predetermined length. Here, the generated fixed-length value or the hash value may be used as the key value of the multimedia file.

The processor 140 determines whether a key value equal to the obtained key value exists in the pre-stored data table, which includes a plurality of key values and character string data of the multimedia file corresponding to each key value (S430), and when the key value equal to the obtained key value exists, the processor 140 may terminate a multimedia file storage/management operation. Here, a data table may be, but is not limited to, a hash table or a hash map in the form of a data structure in which a key and a value may be mapped.

When the key value equal to the obtained key value does not exist, the processor 140 matches the obtained key value to the generated character string data and stores the key value and character string data in the data table (S440).

The processor 140 transmits a multimedia file corresponding to the obtained key value to the server 200 (S440). In other words, processor 140 may transmit the multimedia file to the server 200 so that the server 200 stores/manages the multimedia file included in the document. In various exemplary embodiments, the processor 140 may also transmit documents including the multimedia file to the server 200.

Thus, in the present disclosure, the server stores the multimedia file once, so that it is possible to save memory capacity for storing multimedia files.

Hereinafter, a method of managing a multimedia file included in a document in a client application of the client device 100 will be described with reference to FIG. 5.

FIG. 5 is an example diagram for illustrating a method of managing a multimedia file included in a document in a client application according to an exemplary embodiment of the present disclosure. In the presented exemplary embodiment, a client application 500 is software for accessing a browser available on the client device 100 to make requests to the server 200, and may be stored in the storage unit 130 of the client device 100. The control unit 140 of the client device 100 may utilize the respective components of the client application 500 stored in the storage unit 130 to perform multimedia file storage and/or management according to the exemplary embodiment of the present disclosure.

Referring to FIG. 5, the client application 500 is an application for storing/managing multimedia files included in a document and may include an obtaining module 510, an encoding module 520, an encryption module 530, and a duplicate detection module 540.

The obtaining module 510 may obtain a multimedia file related to a document. In order to obtain the multimedia file, the obtaining module 510 may analyze the document to obtain at least one element consisting of the document and attribute information for each element, and check when at least one element includes a multimedia file. Here, at least one element may include a paragraph, text, figure, table, formula, and/or image. For example, the obtaining module 510 may obtain at least one element, such as a figure, table, formula, and/or image, as a multimedia file. The encoding module 520 may encode the obtained multimedia file to generate character string data. For example, the encoding module 520 may utilize a character string encoding scheme, such as base64, as described above, but is not limited to.

The encryption module 530 may encrypt the generated character string data to generate a unique key value (UniqueID, UID). Here, the UID may be, but is not limited to, a hash value obtained by hashing the multimedia file.

By using a data table 550 that stores a plurality of key values and character string data corresponding to each key value, the duplicate detection module 540 may determine whether a key value equal to the key value generated by the hash module 530 exists.

When the key value equal to the generated key value exists, character string data corresponding to the corresponding key value exists, so that it may be understood that a multimedia file corresponding to the character string data is already stored in the server 200. In such cases, the multimedia file storage/management operation of the client application 500 may be terminated.

When the key value equal to the generated key value does not exist, the duplicate detection module 540 may match the generated key value and the generated character string data and store the generated key value and the generated character string data in a data table 550.

The client application 500 may request that the server 200 stores the multimedia file corresponding to the generated key value. In other words, the client application 500 may transmit the multimedia file corresponding to the generated key value to the server application 700 so that the server 200 stores the multimedia file corresponding to the generated key value.

Thus, in the present disclosure, the client device performs duplicate detection for storing multimedia files, so that it is possible to prevent wastage of memory capacity due to duplicate storage of multimedia files.

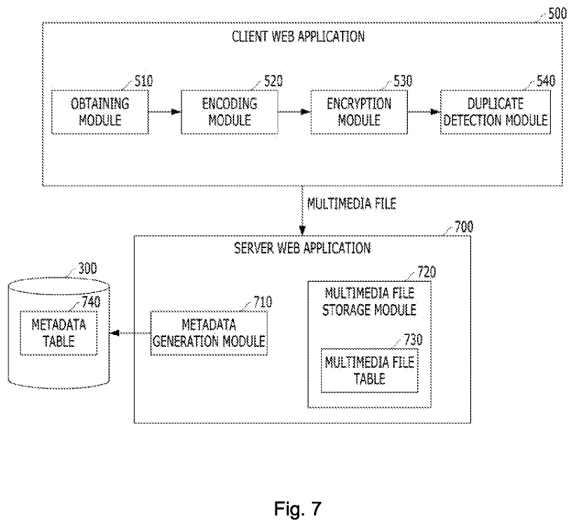

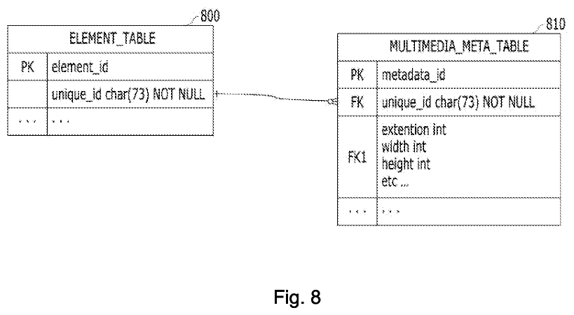

Hereinafter, a method of storing/managing a multimedia file by the server 200 will be described in detail with reference to FIGS. 6 and 7.

FIG. 6 is a flow diagram for illustrating one example of a method of storing/managing a multimedia file according to some exemplary embodiments of the present disclosure. In the presented exemplary embodiment, the operations of FIG. 6 may be performed by the processor 230 of the server 200.

Referring to FIG. 6, the processor 230 receives a multimedia file corresponding to a specific key value from a client device (S600) and generates metadata for the received multimedia file (S610).

The processor 230 stores the received multimedia file in a pre-stored multimedia file table, which includes a plurality of key values and a multimedia file corresponding to each key value (S620). In other words, the processor 230 may store a specific key value and a multimedia file corresponding to the specific key value in the multimedia file table.

The processor 230 stores the generated metadata in the pre-stored metadata table, which includes a plurality of key values and metadata corresponding to each key value (S630). In other words, the processor 230 may store a specific key value and metadata generated in response to the specific key value in a metadata table.

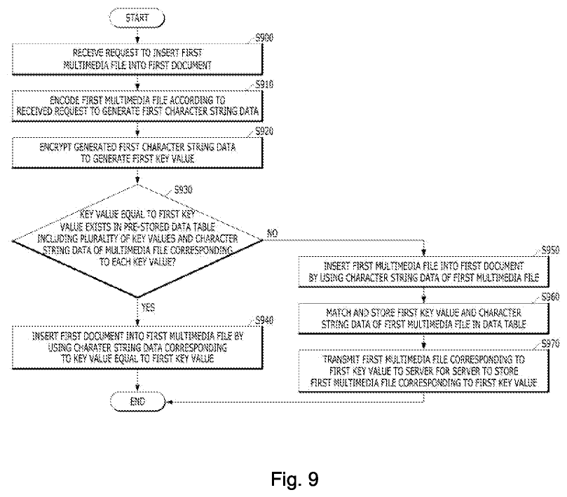

The processor 230 associates the multimedia file stored in the multimedia file table with metadata stored in the metadata table by using the specific key value (S640). Here, the specific key value may be used as a foreign key. The method of associating the multimedia file and the metadata by using the foreign key as described above will be described in detail with reference to FIG. 8.

Hereinafter, a method of storing/managing a multimedia file in a server application of the server 200 will be described with reference to FIG. 7.

FIG. 7 is an example diagram for illustrating a method of storing/managing a multimedia file in a server application according to an exemplary embodiment of the present disclosure. In the presented exemplary embodiment, the server application 700 is software for performing processing on a request received from the client application 500 of the client device 100 and transmitting a response to the request, and may be stored in the storage unit 220 of the server 200. The control unit 230 of the server 200 may perform storage and/or management of the multimedia file according to the exemplary embodiment of the present disclosure by using each component of the server application 700 stored in the storage unit 220.

Referring to FIG. 7, the server application 700 is an application server for storing/managing a multimedia file provided from the client device 100 and/or a document including at least one multimedia file, and may include a metadata generation module 710 and a multimedia file storage module 720.

The metadata generation module 710 may process or generate metadata for the multimedia file received from the client application 500 according to the request of the client application 500. The metadata generated by the metadata generation module 710 may be stored in the database 300 related to the server 200. The database 300 may store a metadata table 740 that includes a plurality of key values and metadata corresponding to each key value. Specifically, the server application 700 may match the metadata processed or generated by the metadata generation module 710 in the metadata table 740 of the database 300 to the key value of the multimedia file and store the metadata and the key value of the multimedia file.

The multimedia file storage module 720 may store the multimedia file table 730 that includes a plurality of key values and a multimedia file corresponding to each key value. Specifically, the server application 700 may match the received multimedia file to a key value of the multimedia file and store the multimedia file and the key value of the multimedia file in the multimedia file table 730 of the multimedia file storage module 720.

The server application 700 may associate the multimedia file stored in the multimedia file storage module 720 with the metadata stored in the database 300 by using foreign keys.

In the following, the method of associating the multimedia file and the metadata by using foreign keys will be described in detail using FIG. 8.

FIG. 8 is an example diagram for illustrating a method of associating a multimedia file and metadata by using a foreign key according to an exemplary embodiment of the present disclosure. In the presented exemplary embodiment, the operations of FIG. 8 may be performed by the processor 230 of the server 200.

Referring to FIG. 8, a multimedia file table (ELEMENT_TABLE) 800 storing multimedia files and a metadata table (MULTIMEDIA_META_TABLE) 810 storing metadata are illustrated.

The multimedia file table (ELEMENT_TABLE) 800 may include an identifier (element_id) of at least one multimedia file, a unique key value of each multimedia file, and a multimedia file. Here, the identifier of the multimedia file is a primary key of the multimedia file table 800, which may be utilized to identify the data included in each row of the multimedia file table 800.

The metadata table (MULTIMEDIA_META_TABLE) 810 may include an identifier (id) of metadata for at least one multimedia file, a unique key value for each multimedia file, and metadata for each multimedia file. Here, the identifier of the metadata is the primary key of the metadata table 810, which may be utilized to identify the data included in each row of the metadata table 810.

A unique key value (unique_id char(73) NOT NULL) of each multimedia file may be used as a foreign key (FK) to associate the multimedia file table 800 and the metadata table 810, as illustrated in FIG. 8. As a result, the multimedia file table 800 may be related to the metadata table 810 in a many-to-one relationship.

Thus, in the present disclosure, the server matches the multimedia file and the data (document or metadata) related to the multimedia file and stores the multimedia file and the data to efficiently manage the multimedia file related to the document.

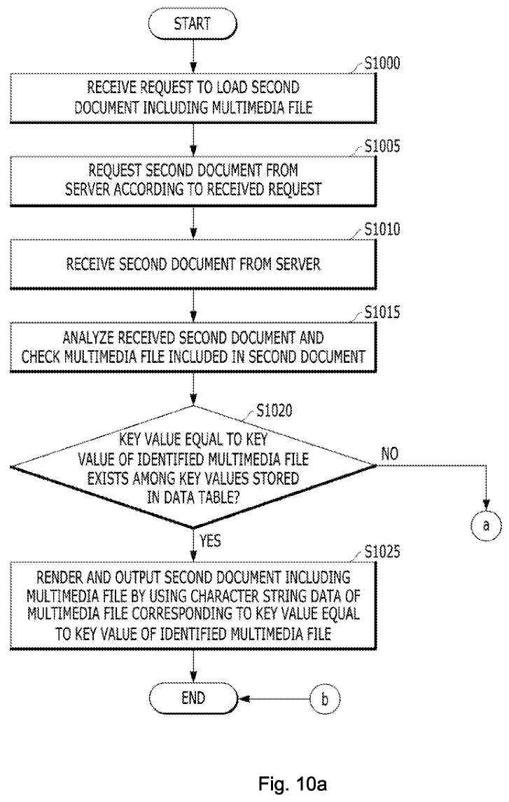

Hereinafter, a method of storing/managing a first multimedia file when the client device 100 receives a request to insert the first multimedia file into a document will be described in detail with reference to FIG. 9.

FIG. 9 is a flow diagram for illustrating one example of a method of storing/managing a first multimedia file upon a request to insert the first multimedia file into a first document according to an exemplary embodiment of the present disclosure. In the presented exemplary embodiment, the operations of FIG. 9 may be performed by the processor 140 of the client device 100.

Referring to FIG. 9, the processor 140 receives a request to insert a first multimedia file into a first document (S800). Here, the first document may be a document stored in the server 200, or a document generated by the client and stored in the client device 100.

Based on the received request, the processor 140 encodes the first multimedia file to generate first character string data (S910) and encrypts the generated first character string data to generate a first key value (S920).

From a pre-stored data table including a plurality of key values and character string data of a multimedia file corresponding to each key value, the processor 140 determines whether a key value equal to the first key value exists (S930), and when the key value equal to the first key value exists, the processor 140 inserts the first multimedia file into the first document by using the character string data corresponding to the key value equal to the first key value (S940). Here, the existence of the key value equal to the first key value may mean that a multimedia file corresponding to the first key value is already stored in the server 200. Therefore, the character string data corresponding to the key value equal to the first key value may be the same character string data corresponding to the multimedia file identical to the character string data corresponding to the first key value. Accordingly, the processor 140 may insert the first multimedia file into the first document by inserting the character string data corresponding to the key value equal to the first key value into the first document.

When the key value equal to the first key value does not exist, the processor 140 inserts the first multimedia file into the first document by using the character string data of the first multimedia file (S950). In other words, the processor 140 may insert the first multimedia file into the first document by inserting the character string data of the first multimedia file into the first document.

The processor 140 matches the first key value and the character string data and stores the first key value and the character string data in a data table (S960), and transmits the first multimedia file corresponding to the first key value to the server 200 so that the server 200 stores the first multimedia file corresponding to the first key value (S970). In other words, the processor 140 may transmit a request to the server 200 for storing the first multimedia file corresponding to the first key value.

According to various exemplary embodiments, when the first document is generated by a client, the processor 140 may also transmit a request to the server 200 to store the first document into which the first multimedia file is inserted, as well as the first multimedia file.

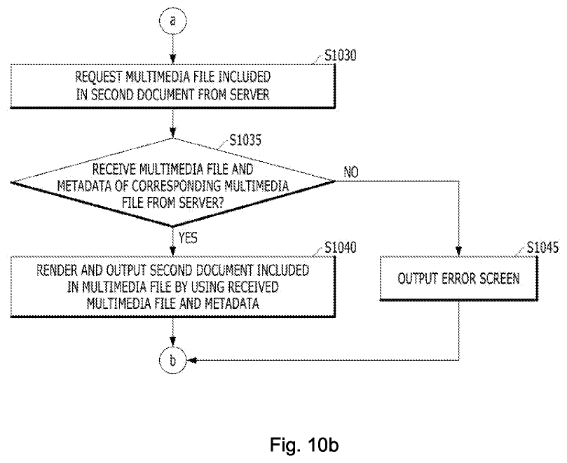

Hereinafter, a method of storing/managing a second multimedia file when the client device 100 receives a request to load a second document including a second multimedia file will be described in detail with reference to FIGS. 10A and 10B.

FIGS. 10A and 10B are flow diagrams for illustrating one example of a method of storing/managing a second multimedia file upon a loading request for a second document including a second multimedia file according to an exemplary embodiment of the present disclosure. In the presented exemplary embodiment, the operations of FIGS. 10A and 10B may be performed by the processor 140 of the client device 100.

Referring to FIG. 10A, the processor 140 receives a request to load a second document including a plurality of multimedia files (S1000). Here, the second document may be a document stored in the server 200.

Based on the received request, the processor 140 requests the second document from the server 200 (S1005) and receives the second document from the server 200 (S1010). In other words, the processor 140 may download the second document desired to be loaded from the server 200. Here, the received second document may include at least one object and attribute information for each object. Attribute information of each object may include a unique key value of the corresponding object.

The processor 140 analyzes the received second document to check the multimedia files included in the second document (S1015), and determines whether a key value equal to a key value of each of the identified plurality of multimedia files exists among the key values stored in the data table (S1020).

When the key value equal to the key value of each of the identified plurality of multimedia files exists, the processor 140 renders and outputs the second document including the multimedia file by using character string data of the multimedia file corresponding to the key value equal to the key value of each of the identified plurality of multimedia files (S1025).

In other words, the processor 140 may obtain, from the character string data stored in the data table, the character string data of the multimedia file corresponding to the key value equal to the key value of each of the identified plurality of multimedia files. Subsequently, the processor 140 may decode the obtained character string data to obtain the multimedia file and render and output the obtained multimedia file and the second document to load the second document including the multimedia file. Here, the method of rendering the second document may be done in the same way as the method of rendering an HTML document or the like through a browser.

Thus, the present disclosure may minimize resources and time required for loading by loading the document including the multimedia files without a separate request from the client device to the server.

On the other hand, when the key value equal to the key value of each of the identified plurality of multimedia files does not exist, the processor 140 proceeds to operation @ of FIG. 10B.

Referring to FIG. 10B, the processor 140 requests the multimedia file included in the second document from the server 200 (S1030) and determines whether the multimedia file and metadata of the corresponding multimedia file are received from the server 200 (S1035).

When the multimedia file and the metadata of the corresponding multimedia file are received from the server 200, the processor 140 renders and outputs the second document including the multimedia file by using the received multimedia file and metadata (S1040).

When the multimedia file and the metadata of the corresponding multimedia file are not received from the server 200, the processor 140 outputs an error screen

(S1045). In various exemplary embodiments, when an error message is received from the server 200, the processor 140 may also output an error screen.

The processor 140 then proceeds to operation b of FIG. 10A to terminate the operation of the method of storing/managing the second multimedia file.

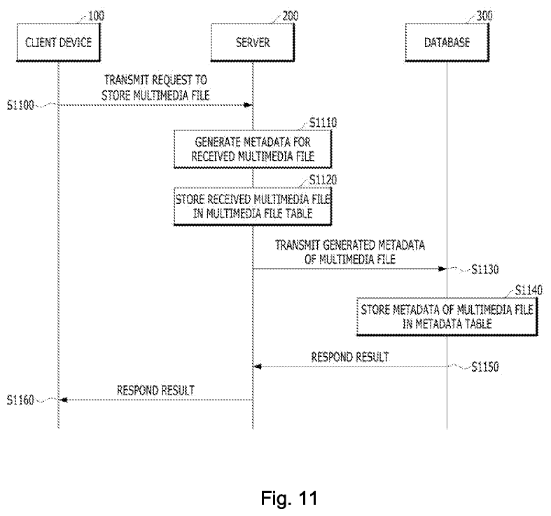

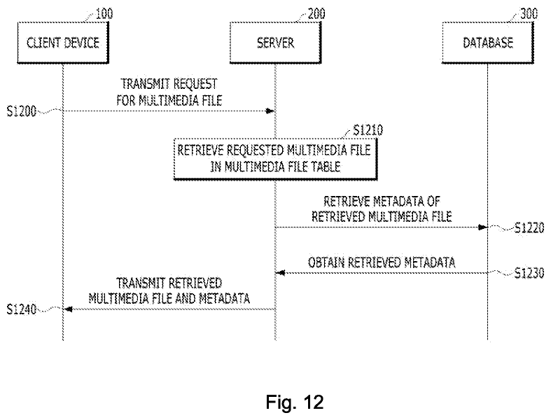

Hereinafter, a method of storing, managing, and/or providing a multimedia file by the server 200 according to a request of the client device 100 will be described in detail with reference to FIGS. 11 and 12

FIG. 11 is a flow diagram for illustrating one example a method of storing a multimedia file by the server according to a request of a client according to some exemplary embodiments of the present disclosure. The presented exemplary embodiment describes a case where the client device 100 stores a multimedia file in a server when the same key value of the multimedia file does not exist when the client device 100 performs a duplicate detection operation on the multimedia file.

Referring to FIG. 11, the client device 100 transmits a request to the server 200 to store the multimedia file (S1100). Here, the request may include a multimedia file desired to be stored in the server 200.

The server 200 generates metadata for the received multimedia files (S1110) and stores the received multimedia files in a multimedia file table (S1120). When storing the received multimedia file, the server 200 may rename the multimedia file with a key value corresponding to the multimedia file and store the multimedia file.

The server 200 transmits the generated metadata of the multimedia file to the database 300 (S1130) and stores the metadata of the multimedia file in the metadata table stored in the database 300 (S1140). In this case, the server 200 may associate the multimedia file table in which the multimedia files are stored and the metadata table in which the metadata of the multimedia files are stored with each other by using key values and foreign keys.

When the storage of the metadata is completed, the database 300 transmits the resulting response to the server 200 (S1150), and the server 200 receiving the resulting response transmits the resulting response to the request from the client device 100 to the client device 100 (S1160).

FIG. 12 is a flow diagram for illustrating one example of a method of providing a multimedia file by the server in response to a client request according to some exemplary embodiments of the present disclosure. The presented exemplary embodiment describes a case where the client device 100 requests a multimedia file from the server 200 when the same key value of the multimedia file does not exist when the client device 100 performs a duplicate detection operation on the multimedia file to load a document including the multimedia file.

According to FIG. 12, a client device 100 delivers a request for a multimedia file to a server 200 (S1200). For example, a client device 100 can transmit a request for a multimedia file included in a document to load the document to a server. Wherein the request for the multimedia file can comprise a key value corresponding to a multimedia file.

In an exemplary embodiment, a server 200 retrieves a requested multimedia file from a multimedia file table (S1210), and retrieves metadata of the retrieved multimedia file from a database 300 (S1220). For example, the server 200 can retrieve a multimedia file having a name of a key value included in a request, from a multimedia file table. Also, the server 200 can retrieve metadata of a multimedia file corresponding to a key value, from a metadata table stored in a database 300.

In an exemplary embodiment, a server 200 obtains metadata retrieved from a database 300 (S1230) and transmits a retrieved multimedia file and metadata to a client device 100 (S1240).

As such, in a present disclosure, a client device and a server can effectively manage a multimedia file related to a document.

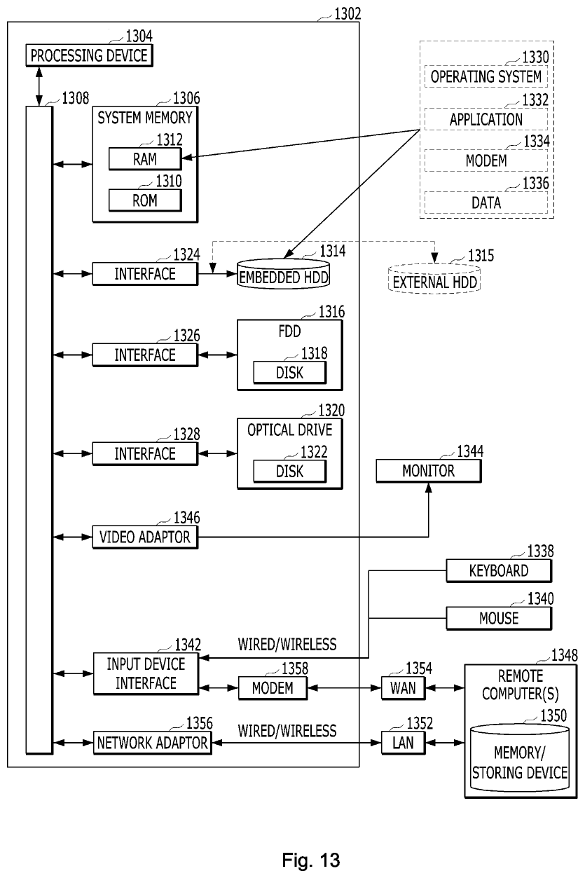

FIG. 13 is a simple and general schematic diagram illustrating an example of a computing environment in which the embodiments of the present disclosure are implementable.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will well appreciate that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a minicomputer, and a main frame computer.

The embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transport medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a RAM, a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1300 including a computer 1302 and implementing several aspects of the present disclosure is illustrated, and the computer 1302 includes a processing device 1304, a system memory 1306, and a system bus 1308. The system bus 1308 connects system components including the system memory 1306 (not limited) to the processing device 1304. The processing device 1304 may be a predetermined processor among various commonly used processors. A dual processor and other multi-processor architectures may also be used as the processing device 1304.

The system bus 1308 may be a predetermined one among several types of bus structure, which may be additionally connectable to a local bus using a predetermined one among a memory bus, a peripheral device bus, and various common bus architectures. The system memory 1306 includes a ROM 1310, and a RAM 1312. A basic input/output system (BIOS) is stored in a non-volatile memory 1310, such as a ROM, an EPROM, and an EEPROM, and the BIOS includes a basic routing helping a transport of information among the constituent elements within the computer 1302 at a time, such as starting. The RAM 1312 may also include a high-rate RAM, such as a static RAM, for caching data.

The computer 1302 also includes an embedded hard disk drive (HDD) 1314 (for example, enhanced integrated drive electronics (EIDE) and serial advanced technology attachment (SATA))—the embedded HDD 1314 being configured for exterior mounted usage within a proper chassis (not illustrated)-a magnetic floppy disk drive (FDD) 1316 (for example, which is for reading data from a portable diskette 1318 or recording data in the portable diskette 1318), and an optical disk drive 1320 (for example, which is for reading a CD-ROM disk 1322, or reading data from other high-capacity optical media, such as a DVD, or recording data in the high-capacity optical media). A hard disk drive 1314, a magnetic disk drive 1316, and an optical disk drive 1320 may be connected to a system bus 1308 by a hard disk drive interface 1324, a magnetic disk drive interface 1326, and an optical drive interface 1328, respectively. An interface 1324 for implementing an outer mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1302, the drive and the medium correspond to the storage of random data in an appropriate digital form. In the description of the computer readable media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1330, one or more application programs 1332, other program modules 1334, and program data 1136 may be stored in the drive and the RAM 1312. An entirety or a part of the operation system, the application, the module, and/or data may also be cached in the RAM 1312. It will be well appreciated that the present disclosure may be implemented by several commercially usable operation systems or a combination of operation systems.

A user may input a command and information to the computer 1302 through one or more wired/wireless input devices, for example, a keyboard 1338 and a pointing device, such as a mouse 1340. Other input devices (not illustrated) may be a microphone, an IR remote controller, a joystick, a game pad, a stylus pen, a touch screen, and the like. The foregoing and other input devices are frequently connected to the processing device 1304 through an input device interface 1342 connected to the system bus 1308, but may be connected by other interfaces, such as a parallel port, an IEEE 1394 serial port, a game port, a USB port, an IR interface, and other interfaces.

A monitor 1344 or other types of display devices are also connected to the system bus 1308 through an interface, such as a video adaptor 1346. In addition to the monitor 1344, the computer generally includes other peripheral output devices (not illustrated), such as a speaker and a printer.

The computer 1302 may be operated in a networked environment by using a logical connection to one or more remote computers, such as remote computer(s) 1348, through wired and/or wireless communication. The remote computer(s) 1348 may be a work station, a computing device computer, a router, a personal computer, a portable computer, a microprocessor-based entertainment device, a peer device, and other general network nodes, and generally includes some or an entirety of the constituent elements described for the computer 1302, but only a memory storage device 1350 is illustrated for simplicity. The illustrated logical connection includes a wired/wireless connection to a local area network (LAN) 1352 and/or a larger network, for example, a wide area network (WAN) 1354. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1302 is used in the LAN networking environment, the computer 1302 is connected to the local network 1352 through a wired and/or wireless communication network interface or an adaptor 1356. The adaptor 1356 may make wired or wireless communication to the LAN 1352 easy, and the LAN 1352 also includes a wireless access point installed therein for the communication with the wireless adaptor 1356. When the computer 1302 is used in the WAN networking environment, the computer 1302 may include a modem 1358, is connected to a communication computing device on a WAN 1354, or includes other means setting communication through the WAN 1354 via the Internet. The modem 1358, which may be an embedded or outer-mounted and wired or wireless device, is connected to the system bus 1308 through a serial port interface 1342. In the networked environment, the program modules described for the computer 1302 or some of the program modules may be stored in a remote memory/storage device 1350. The illustrated network connection is illustrative, and those skilled in the art will appreciate well that other means setting a communication link between the computers may be used.

The computer 1302 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, magnetic fields or particles, optical fields or particles, or a predetermined combination thereof.

Those skilled in the art will appreciate that the various illustrative logical blocks, modules, processors, means, circuits, and algorithm operations described in relationship to the embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented embodiments is provided so as for those skilled in the art to use or carry out the present disclosure. Various modifications of the embodiments may be apparent to those skilled in the art, and general principles defined herein may be applied to other embodiments without departing from the scope of the present disclosure. Accordingly, the present disclosure is not limited to the embodiments suggested herein, and shall be interpreted within the broadest meaning range consistent to the principles and new characteristics presented herein.

1. A method for managing a multimedia file related to a document, the method being performed by a first computing device, the method comprising:
obtaining a multimedia file related to a document;
generating character string data by encoding the multimedia file;
generating a key value by encrypting the generated character string data;
determining whether a key value equal to the generated key value exists in a pre-stored data table comprising a plurality of key values and character string data of the multimedia file corresponding to each key value;
when the key value equal to the generated key value does not exist, storing the key value and the character string data in the data table by matching the generated key value and the generated character string data; and
transmitting the multimedia file related to the document to a server so that the server stores the multimedia file related to the document.

2. The method of claim 1, wherein the multimedia file related to the document comprises a multimedia file inserted into the document, or a multimedia file included in the document.

3. The method of claim 1, further comprising:
receiving a request for inserting a first multimedia file into the document;
generating first character string data by encoding the first multimedia file according to the received request;
generating a first key value by encrypting the first character string data;
determining whether a key value equal to the first key value exists in the data table; and
when the key value equal to the first key value exists, inserting the first multimedia file into the document by using the character string data from the multimedia file corresponding to the key value equal to the first key value.

4. The method of claim 3, wherein the inserting of the first multimedia file into the document by using the character string data from the multimedia file corresponding to the key value equal to the first key value comprises inserting character string data of the multimedia file corresponding to the key value equal to the first key value into the document.

5. The method of claim 3, further comprising:
inserting the first multimedia file into the document when the key value equal to the first key value does not exist;
storing the first key value and the first character string data in the data table by matching the first key value and the first character string data; and
transmitting the first multimedia file corresponding to the first key value to the server so that the server stores the first multimedia file corresponding to the first key value.

6. The method of claim 1, further comprising:
receiving a request for loading a second document;
determining, in response to the received request, whether a key value equal to a second key value of a second multimedia file included in the second document exists in the pre-stored data table; and
when the key value equal to the second key value exists, loading the second document by using character string data corresponding to the key value equal to the second key value.

7. The method of claim 6, wherein the loading of the second document by using character string data corresponding to the key value equal to the second key value comprises:
rendering each page of the second document;
rendering the second multimedia file of the second document by decoding the character string data; and
outputting each of the rendered pages and the rendered second multimedia file.

8. The method of claim 6, further comprising:
when the key value equal to the second key value does not exist, requesting the second multimedia file to the server;
when the second multimedia file is received from the server, rendering each page of the second document and the received second multimedia file; and
outputting each of the rendered pages and the rendered second multimedia file.

9. A method for managing a multimedia file related to a document, the method being performed by a second computing device, the method comprising:
receiving a multimedia file corresponding to a key value from a client device;
generating metadata for the multimedia file;
storing the received multimedia file in a pre-stored multimedia file table comprising a plurality of multimedia files; and
storing the generated metadata in a metadata table that comprises metadata of each of the plurality of multimedia files and wherein the metadata table is pre-stored in a database.

10. The method of claim 9, wherein the storing of the received multimedia file in the multimedia file table comprises storing an ID of the multimedia file, the key value, and the multimedia file in the multimedia file table by matching the ID of the multimedia file, the key value, and the multimedia file.

11. The method of claim 10, wherein the storing of the generated metadata in the metadata table comprises storing the key value and the metadata in the metadata table by matching the key value and the metadata.

12. The method of claim 11, wherein a multimedia file stored in the multimedia file table and a metadata file stored in the metadata table are associated to each other by the key value.

13. The method of claim 9, further comprising:
receiving a request for a multimedia file corresponding to the key value from the client device;
retrieving, in accordance with the received request, the requested multimedia file from the multimedia file table;
retrieving metadata of the requested multimedia file from the metadata table stored in the database; and
transmitting the retrieved multimedia file and the retrieved metadata to the client device.

14. A computer program stored in a computer readable storage medium,
wherein when the computer program is executed by one or more processors, the computer program performs following operations for managing a multimedia file related to a document, the operations comprising:
obtaining a multimedia file related to a document;
generating character string data by encoding the multimedia file;
generating a key value by encrypting the generated character string data;
determining whether a key value equal to the generated key value exists in a pre-stored data table comprising a plurality of key values and character string data of the multimedia file corresponding to each key value;
when the key value equal to the generated key value does not exist, storing the key value and the character string data in the data table by matching the generated key value and the generated character string data; and
transmitting the multimedia file related to the document to a server so that the server stores the multimedia file related to the document.

15. A computing device for managing a multimedia file related to a document, the computing device comprising:
at least one processor; and
a memory,
wherein said at least one processor:
obtains a multimedia file related to a document,
generates character string data by encoding the multimedia file;
generates a key value by encrypting the generated character string data;
determines whether a key value equal to the generated key value exists in a pre-stored data table comprising a plurality of key values and character string data of the multimedia file corresponding to each key value;
when the key value equal to the generated key value does not exist, stores the key value and the character string data in the data table by matching the generated key value and the generated character string data; and
transmits the multimedia file related to the document to a server so that the server stores the multimedia file related to the document.
